(19) United States
(12) Patent Application Publication
(10) Pub. No.: US 2012/0280648 A1
(43) Pub. Date: Nov. 8, 2012

(54) APPARATUS AND METHOD FOR CHARGING WIRELINE AND WIRELESS POWERS

(75) Inventors: Sang Hoon Hwang, Seoul (KR); Young Seok Yoon, Chungcheongnam-do (KR); Kwang Du Lee, Gyunggi-do (KR); Chul Gyun Park, Gyunggi-do (KR); Jae Suk Sung, Gyunggi-do (KR); Jung Ho Yoon, Gyunggi-do (KR); Eung Ju Kim, Suwon (KR); Jeong Hoon Kim, Seoul (KR)

(73) Assignee: SAMSUNG ELECTRO-MECHANICS CO., LTD., Gyunggi-do (KR)

(21) Appl. No.: 13/184,819

(22) Filed: Jul. 18, 2011

(30) Foreign Application Priority Data
May 4, 2011 (KR) 1020110042653

(51) Int. Cl. H02J 7/00

(52) U.S. Cl. 320/108

(57) ABSTRACT

Disclosed herein are an apparatus and a method for charging wireline and wireless powers. The apparatus for charging wireline and wireless powers includes: a main battery; an auxiliary battery; a wireline charging module providing wireline power to the main and auxiliary batteries; and a wireless charging module connected to the wireline charging module to thereby provide wireless power to the main and auxiliary batteries. Therefore, wireline charging and the wireless charging may be simultaneously performed, thereby making it possible to save a time required to charge power and to improve the convenience for users according to various charging scenarios using the wireline charging and the wireless charging.

### CROSS REFERENCE TO RELATED APPLICATION

This application claims the benefit of Korean Patent Application No. 10-2011-0042653, filed on May 4, 2011, entitled “Power Charging Apparatus And Charging Method For Both Wireline And Wireless”, which is hereby incorporated by reference in its entirety into this application.

### BACKGROUND OF THE INVENTION

1. Technical Field

The present invention relates to an apparatus and a method for charging wireline and wireless powers.

2. Description of the Related Art

In accordance with the development of information technology (IT), a communication system has been rapidly developed in 2000s based on an infinitely expanded area called a wireless area.

As a result, the communication system has newly changed into a user-oriented system that is not restricted by place and time and may be conveniently carried by a user.

However, in spite of the development of the communication system, transmission of power and energy and depends upon a wireline system, such that there are many restrictions in the place and the time when the system is actually used.

In order to solve this problem, research into a technology of providing power to an electronic product including a mobile device in wireless to thereby charge the power in the electronic product has been actively conducted. As a result, an apparatus and a method for charging power in wireless as well as in wireline using a single charging device have been currently disclosed.

However, in the case of the apparatus and the method for charging wireline and wireless powers according to the prior art, at the time of charging of the power in a plurality of batteries, one of a method for charging wireline power and a method for charging wireless power need to be selected and the power need to be sequentially charged in the plurality of battery through the selected method.

For example, in the case of charging the power in an electronic product including a main battery and an auxiliary battery, when it takes two hours to completely charge the power in each of the main battery and the auxiliary battery, it takes four hours to charge the power in all of the main battery and the auxiliary battery.

In addition, when the charging is stopped within two hours due to a situation of a user, power according to a corresponding time is charged in the main battery; however, no power is charged in the auxiliary battery.

### SUMMARY OF THE INVENTION

The present invention has been made in an effort to provide an apparatus and a method for charging wireline and wireless powers in which wireline charging and wireless charging may be simultaneously performed.

Further, the present invention has been made in an effort to provide an apparatus and a method for charging power according to various charging scenarios using wireline charging and wireless charging.

According to a first preferred embodiment of the present invention, there is provided an apparatus for charging wireline and wireless powers, the apparatus including: a main battery; an auxiliary battery; a wireline charging module providing wireline power to the main and auxiliary batteries; and a wireless charging module connected to the wireline charging module to thereby provide wireless power to the main and auxiliary batteries.

The wireline charging module may include: a wireline power receiver receiving the wireline power; a charging circuit charged with the wireline power received from the wireline power receiver and the wireless power received from the wireless charging module; a DC/DC converter converting power of the auxiliary battery; a first switch installed between the wireline power receiver and the main battery to thereby connect or disconnect the wireline power receiver and the main battery to or from each other; a second switch installed between the wireline power receiver and the charging circuit and between the wireless charging module and the charging circuit to thereby connect or disconnect the wireline power receiver and the charging circuit to or from each other and connect or disconnect the wireless charging module and the charging circuit to or from each other; and a microcontrol unit controlling the first and second switches and the DC/DC converter so as to supply the wireline and wireless powers to the main and auxiliary batteries or stop the supply of the wireline and wireless powers to the main and auxiliary batteries according to control signals for each charging mode.

The wireless charging module may include: a wireless power receiver receiving the wireless power; a rectifier rectifying the wireless power; and a regulator stabilizing the rectified wireless power into a constant voltage.

The wireless charging module may further include a matcher matching an impedance between the wireless power receiver and the rectifier.

According to a second preferred embodiment of the present invention, there is provided a method for charging wireline and wireless powers, the method including: (A) simultaneously charging wireline and wireless powers in a main battery and an auxiliary battery when a first charging mode signal is input; (B) determining whether a second charging mode signal is input and charging wireline power in the main battery and the auxiliary battery when the second charging mode signal is input; and (C) determining whether a third charging mode signal is input and charging wireless power in the main battery and the auxiliary battery when the third charging mode signal is input.

Step (A) may include: (A-1) simultaneously switching on a first switch installed between a wireline power receiver and a main battery and a second switch installed between a wireless charging module and a charging circuit when the first charging mode signal is input; and (A-2) charging wireless power received from the wireless charging module in the charging circuit simultaneously with charging wireline power received from the wireline power receiver in the main battery to thereby charge the powers in the auxiliary battery connected to the charging circuit.

Step (B) may include: (B-1) switching on a first switch installed between a wireline power receiver and the main battery when the second charging mode signal is input; (B-2) charging wireline power received from the wireline power receiver in the main battery; (B-3) determining whether the charging of the power in the main battery is completed; (B-4) switching on a second switch installed between the wireline power receiver and a charging circuit when the charging of the power in the main battery is completed; and (B-5) charging wireline power received from the wireline power receiver in the charging circuit to thereby charge the wireline power in the auxiliary battery connected to the charging circuit.

Step (C) may include: (C-1) switching on a second switch installed between a wireless charging module and a charging circuit when the third charging mode signal is input; (C-2) charging wireless power received from the wireless charging module in the charging circuit to thereby charge the wireless power in the auxiliary battery connected to the charging circuit; (C-3) determining whether a charging amount of the wireless power charged in the auxiliary battery is a preset value or more; (C-4) determining whether a main battery charging signal is input when the charging amount of the wireless power is the preset value or more; and (C-5) converting the wireless power in the auxiliary battery to thereby charge the converted power in the main battery when the main battery charging signal is input.

### BRIEF DESCRIPTION OF THE DRAWINGS

FIG. 1 is a block diagram showing an apparatus for charging wireline and wireless powers according to a preferred embodiment of the present invention;

FIG. 2 is flow chart showing a method for charging wireline and wireless powers according to a preferred embodiment of the present invention;

FIG. 3 is a flow chart showing the method for simultaneously charging wireline and wireless powers shown in FIG. 2;

FIG. 4 is a flow chart showing a method for charging wireless power in an auxiliary battery shown in FIG. 3;

FIG. 5 is a flow chart showing the method for charging wireline power shown in FIG. 2; and

FIG. 6 is a flow chart showing the method for charging wireless power shown in FIG. 2.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description and preferred embodiments taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

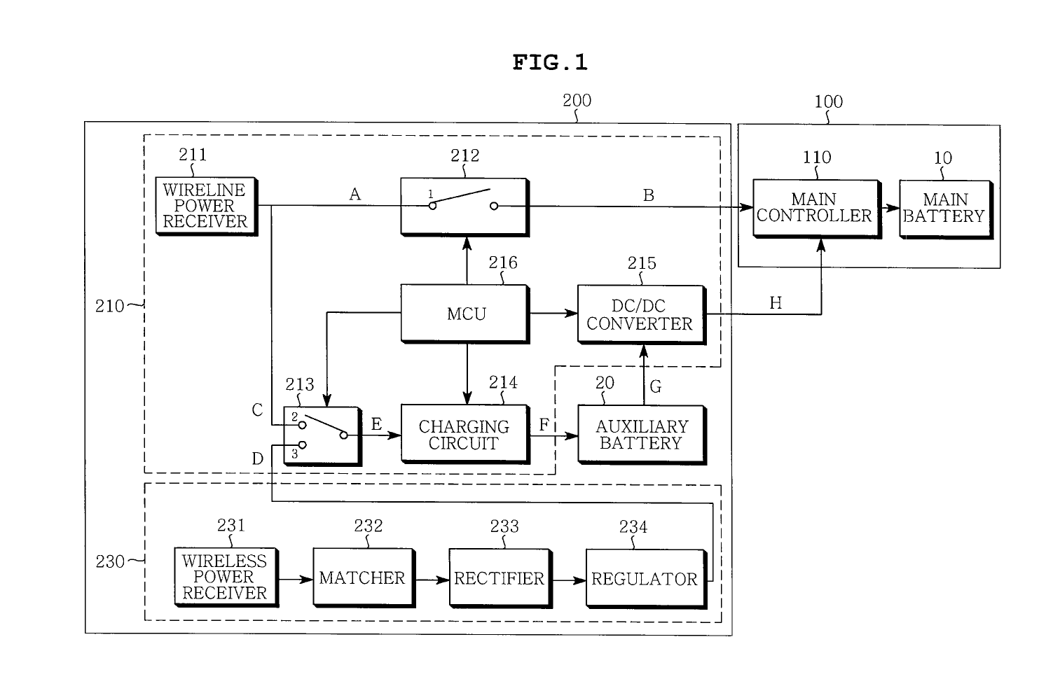

FIG. 1 is a block diagram showing an apparatus for charging wireline and wireless powers according to a preferred embodiment of the present invention.

Referring to FIG. 1, an apparatus for charging wireline and wireless powers according to a preferred embodiment of the present invention is configured to include a main battery 10, an auxiliary battery 20, a wireline charging module 210, and a wireless charging module 230.

The main battery 10 is embedded in a main device 100 such as a mobile device to thereby supply power required for driving the main device 100 to the main device 100.

Here, the main device 100 may further include a main controller 110 in addition to the main battery 10.

The main controller 110 generates control signals according to various charging mode signals selected by users and provides the control signals to a microcontrol unit (MCU) 216 to be described below.

The auxiliary battery 20 is embedded in an auxiliary device 200 such as an auxiliary case connected to the main device 100 to thereby supply power required to drive the main device 100 to the main device 100 at the time of discharging of the main battery 10.

The wireline charging module 210, which provides wireline power to the main battery 10 and the auxiliary battery 20, is configured to include a wireline power receiver 211, a first switch 212, a second switch 213, a charging circuit 214, a direct current (DC)/DC converter 215, and a microcontrol unit (MCU) 216.

The wireline power receiver 211 receives wireline power supplied through a wireline power supplying terminal such as a universal serial bus (USB).

The first switch 212 is installed between the wireline power receiver 211 and the main battery 10 to thereby connect or disconnect the wireline power receiver 211 and the main battery 10 to or from each other.

When the first switch 212 switches on, wireline power received from the wireline power receiver 211 is supplied to the main battery 10 to thereby be charged therein.

When the first switch 212 switches off, the supply of the wireline power received from the wireline power receiver 211 to the main battery 10 is stopped.

The second switch 213 is installed between the wireline power receiver 211 and the charging circuit 214 and between a wireless charging module 230 to be described below and the charging circuit 214 to thereby connect or disconnect the wireline power receiver 211 and the charging circuit 214 to or from each other and connect or disconnect the wireless charging module 230 and the charging circuit 214 to or from each other.

The charging circuit 214 is charged with wireline power received from the wireline power receiver 211 or wireless power received from the wireless charging module 230, according to an operation of the second switch 213.

That is, when the second switch 213 switches on toward a wireline terminal 1 of the wireline power receiver 211, the wireline power is charged in the charging circuit 214, and when the second switch 213 switches on toward a wireless terminal 2 of the wireless charging module 230, the wireless power is charged in the charging circuit 214.

The wireline power or the wireless power charged in the charging circuit 214 is supplied to the auxiliary battery 20 connected to the charging circuit 214 to thereby be charged in the auxiliary battery 20.

When the wireless power is charged in the charging circuit 214, the DC/DC converter 215 converts the wireless power supplied to the auxiliary battery 20 into power used in the main battery 10.

Here, the wireless power DC-DC converted through the DC/DC converter 215 may be supplied to the main battery 10 to thereby be charged in the main battery 10 in wireless.

The MCU 216 controls each component of the wireline charging module 210 so as to charge the wireline power and the wireless power in the main battery 10 and the auxiliary battery 20 by various methods according to control signals according to a charging mode transferred from the main controller 110.

Meanwhile, the wireless charging module 230 is configured to include a wireless power receiver 231, a rectifier 233, and a regulator 234.

The wireless power receiver 231 receives power in wireless.

The wireless power receiver 231 may be formed of, for example, a magnetic coil receiving the wireless power through a magnetic induction scheme, an LC resonant antenna receiving the wireless power through a magnetic resonance scheme, or the like; however, it is not limited thereto. Various types of wireless power receiving device may be used.

The rectifier 233 rectifies the wireless power received from the wireless power receiver 231.

The regulator 234 stabilizes the wireless power rectified through the rectifier 233 into a constant voltage. Here, a low dropout (LDO) may be used as the regulator 234.

In addition, the wireless charging module 230 may further include a matcher 232 installed between the wireless power receiver 231 and the rectifier 233 to thereby match an impedance therebetween.

When the second switch 213 switches on toward the wireless terminal 2 of the wireless charging module 230, the wireless power received through the wireless charging module 230 is charged in the charging circuit 214 to thereby be supplied to the auxiliary battery 20.

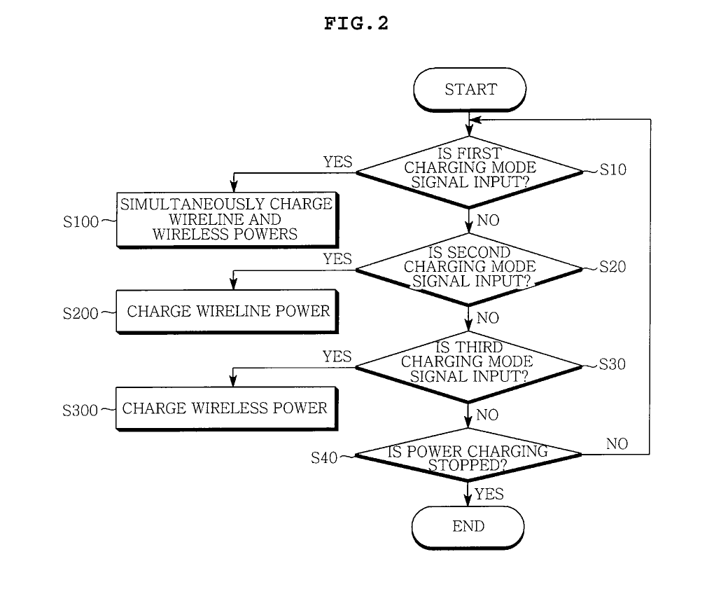

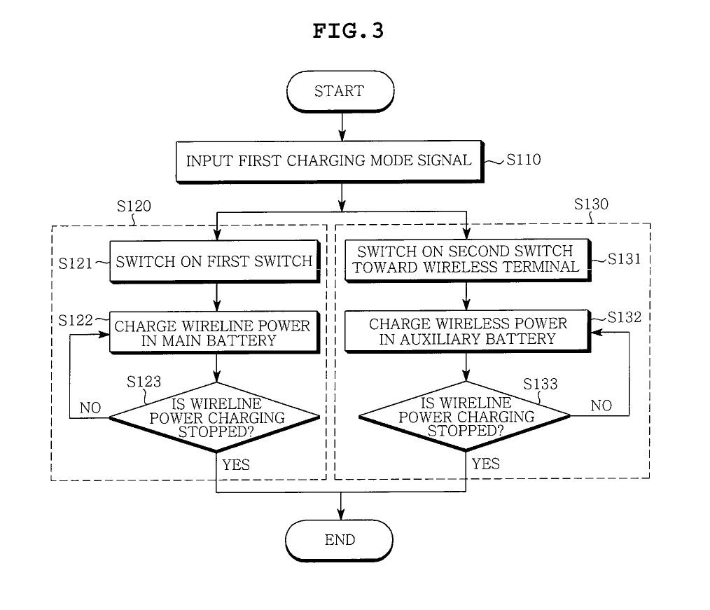

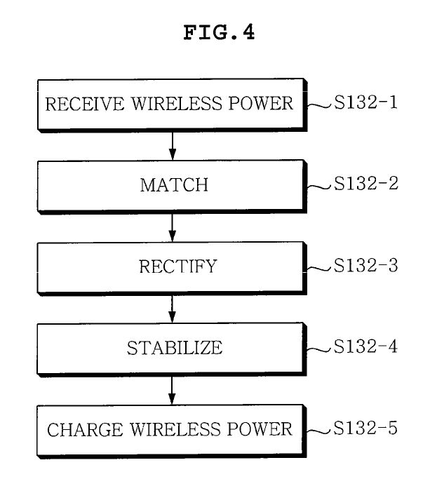

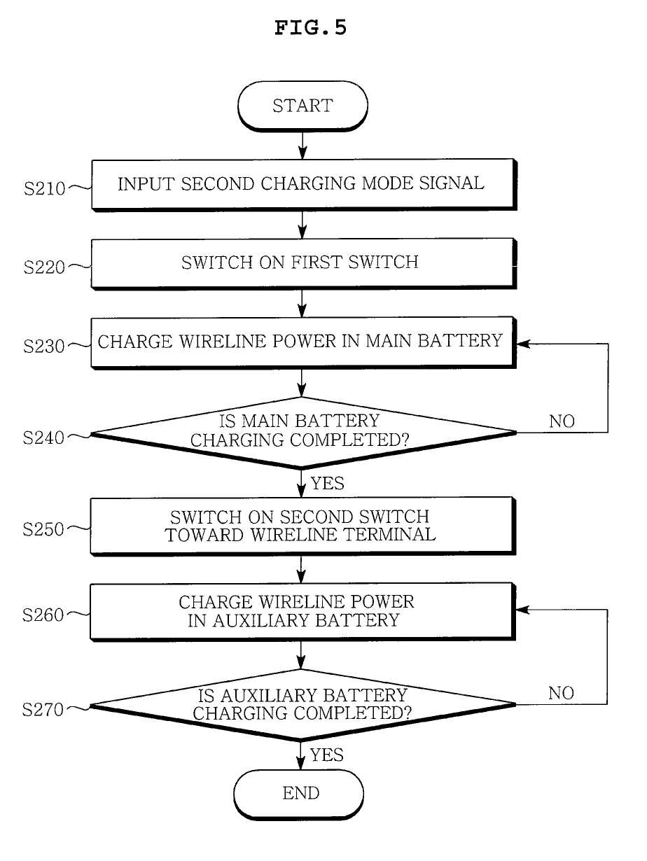

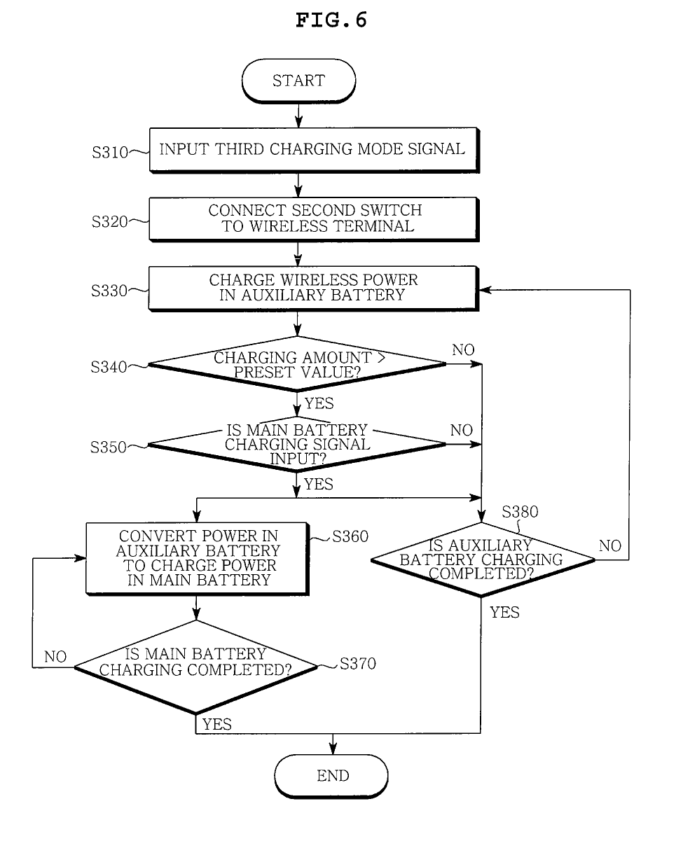

FIG. 2 is flow chart showing a method for charging wireline and wireless powers according to a preferred embodiment of the present invention; FIG. 3 is a flow chart showing the method for simultaneously charging wireline and wireless powers shown in FIG. 2; FIG. 4 is a flow chart showing a method for charging wireless power in an auxiliary battery shown in FIG. 3; FIG. 5 is a flow chart snowing the method for charging wireline power shown in FIG. 2; and FIG. 6 is a flow chart showing the method for charging wireless power shown in FIG. 2.

First, referring to FIG. 2, a method for charging wireline and wireless powers according to a preferred embodiment of the present invention includes determining whether a first charging mode signal is input (S10) and simultaneously charging wireline and wireless powers when the first charging mode signal is input (S100), determining whether a second charging mode signal is input when the first charging mode signal is not input (S20) and charging wireline power when the second charging mode signal is input (S200), and determining whether a third charging mode signal is input when the second charging mode signal is not input (S30) and charging wireless power when the third charging mode signal is input (S300).

In addition, the method for charging wireline and wireless powers according to a preferred embodiment of the present invention may further include determining whether a charging end signal is input when the third charging mode signal is not input (S40).

When it is determined in operation (S40) that the charging end signal is input, charging the power in the main battery 10 and the auxiliary battery 20 is stopped, and when it is determined in operation (S40) that the charging end signal is not input, a process returns to operation (S10), such that subsequent operations are repeated.

More specifically, the simultaneous charging of the wireline and wireless powers (S100) includes charging wireless power received in wireless in the auxiliary battery 20 (S130) simultaneously with charging wireline power received in wireline in the main battery 10 (S120) when the first charging mode signal is input (S110), as shown in FIG. 3.

More specifically, when the first charging mode signal is input, the charging of the wireline power received in wireline in the main battery 10 (S120) includes switching on the first switch 212 installed between the wireline power receiver 211 and the main battery 10 (S121) and supplying the wireline power received in wireline through the wireline power receiver 211 to the main battery 10 to thereby charge the wireline power in the main battery 10 (S122).

Then, it is determined whether a wireline charging end signal is input (S123). When it is determined that the wireline charging end signal is input, the first switch 212 switches off to thereby end the charging of the wireline power in the main battery 10, and when it is determined that the wireline charging end signal is not input, the wireline power is continuously charged in the main battery 10.

The charging of the wireless power received in wireless in the auxiliary battery (S130) performed simultaneously with the charging of the wireline power received in wireline in the main battery 10 (S120) includes switching on the second switch 213 installed between the wireless charging module 230 and the charging circuit 214 toward the wireless terminal 2 of the wireless charging module 230 (S131) and charging the wireless power received in wireless through the wireless charging module 230 in the charging circuit 214 to thereby supply the wireless power to the auxiliary battery 20 connected to the charging circuit 214 and charging the wireless power therein (S132).

Then, it is determined whether a wireless charging end signal is input (S133). When it is determined that the wireless charging end signal is input, the second switch 213 switches off to thereby end the charging of the wireless power in the auxiliary battery 20, and when the wireless charging end signal is not input, the wireless power is continuously charged in the auxiliary battery 20.

Here, the charging of the wireless power received through the wireless charging module 230 in the auxiliary battery 20 (S132) includes receiving the wireless power through the wireless power receiver 231 (S132-1), rectifying the received wireless power through the rectifier 233 (S132-3), stabilizing the rectified wireless power into a constant voltage through the regulator 234 (S132-4), and charging the stabilized wireless power in the charging circuit 214, thereby charging the wireless power in the auxiliary battery 20 (S132-5), as shown in FIG. 4.

In addition, the charging of the wireless power received through the wireless charging module 230 in the auxiliary battery 20 (S132) may further include matching an impedance between the wireless power receiver 231 and the rectifier 233 after the receiving of the wireless power through the wireless power receiver 231 (S132-1).

Meanwhile, the charging of the wireline power (S200) includes switching on the first switch 212 installed between the wireline power receiver 211 and the main battery 10 (S220) and supplying the wireline power received in wireline through the wireline power receiver 211 to the main battery 10 to thereby charge the wireline power therein (S230), when the second charging mode signal is input (S210), as shown in FIG. 5.

Then, it is determined whether a main battery charging end signal is input (S240). When it is determined that the main battery charging end signal is input, the first switch 212 switches off to thereby stop the supply of the wireline power from the wireline power receiver 211 to the main battery 10 and the second switch 213 installed between the wireline power receiver 211 and the charging circuit 214 switches on toward the wireline terminal 1 of the wireline power receiver 211 (S250) and the wireline power received in wireline through the wireline power receiver 211 is charged in the charging circuit 214, such that the wireline power is supplied to and charged in the auxiliary battery 20 connected the charging circuit 214 (S260).

Then, it is determined whether an auxiliary battery charging end signal is input (S270). When it is determined that the auxiliary battery charging end signal is input, the second switch 213 switches off to thereby end the charging of the wireline power in the auxiliary battery 20, and when it is determined that the auxiliary battery charging end signal is not input, the wireline power is continuously charged in the auxiliary battery 20.

Finally, the charging of the wireless power (S300) includes switching on the second switch 213 installed between the wireless charging module 230 and the charging circuit 214 toward the wireless terminal 2 of the wireless charging module 230 (S320) and charging the wireless power received from the wireless charging module 230 in the charging circuit 214 to thereby supply the wireless power to the auxiliary battery 20 connected to the charging circuit 214 and charge the wireless power therein (S330), when the third charging mode signal is input (S310), as shown in FIG. 6.

Here, the charging of the wireless power received through the wireless charging module 230 in the auxiliary battery 20 (S330) are the same as the charging of the wireless power received through the wireless charging module 230 in the auxiliary battery 20 (S132) as shown in FIG. 4. Therefore, a detailed description thereof will be substituted with the above-mentioned description.

Then, it is determined whether an amount charged in the auxiliary battery 20 is a preset value or more (S340).

When it is determined in operation (S340) that the amount charged in the auxiliary battery 20 is a preset value or more, it is determined whether a main battery charging signal is input (S350).

When it is determined in operation (S350) that the main battery charging signal is input, the wireless power in the auxiliary battery 20 is converted into power appropriate for the main battery 10 and the converted wireless power is supplied to and charged in the main battery 10 (S360).

Then, it is determined whether the main battery charging end signal is input (S370). When it is determined that the main battery charging end signal is input, the second switch 213 switches off to thereby end the charging of the wireless power in the main battery 10, and when it is determined that the main battery charging end signal is not input, the wireless power is continuously charged in the main battery 10.

Meanwhile, it is determined in operation (S340) that the amount charged in the auxiliary battery 20 is the preset value or less, it is determined whether the auxiliary battery charging end signal is input (S380). When it is determined that the auxiliary battery charging end signal is input, the second switch 213 switches off to thereby end the charging of the wireless power in the auxiliary battery 20, and when it is determined that the auxiliary battery charging end signal is not input, a process returns to operation (S330), such that subsequent operations are repeated.

As described above, with the apparatus and the method for charging wireline and wireless powers according to the preferred embodiment of the present invention, both of the main battery and the auxiliary battery may be simultaneously charged, such that a charging time may be saved and the main battery and the auxiliary battery may be charged by various methods according to various charging scenarios through wireline charging and wireless charging, thereby making it possible to improve the convenience for users.

According to the preferred embodiments of the present invention, the main battery is charged by wireline charging and the auxiliary battery is charged by wireless charging, such that the wireline charging and the wireless charging may be simultaneously performed, thereby making it possible to save time required to charge power.

In addition, according to the preferred embodiments of the present invention, it is possible to improve the convenience for users according to various charging scenarios using the wireline charging and the wireless charging.

While the present invention has been shown and described in connection with the preferred embodiments, it will be apparent to those skilled in the art that modifications and variations can be made without departing from the spirit and scope of the invention as defined by the appended claims.

What is claimed is:

1. An apparatus for charging wireline and wireless powers, the apparatus comprising:
a main battery;
an auxiliary battery;
a wireline charging module providing wireline power to the main and auxiliary batteries; and
a wireless charging module connected to the wireline charging module to thereby provide wireless power to the main and auxiliary batteries.

2. The apparatus as set forth in claim 1, wherein the wireline charging module includes:
a wireline power receiver receiving the wireline power:
a charging circuit charged with the wireline power received from the wireline power receiver and the wireless power received from the wireless charging module;
a DC/DC converter converting power of the auxiliary battery;
a first switch installed between the wireline power receiver and the main battery to thereby connect or disconnect the wireline power receiver and the main battery to or from each other;
a second switch installed between the wireline power receiver and the charging circuit and between the wireless charging module and the charging circuit to thereby connect or disconnect the wireline power receiver and the charging circuit to or from each other and connect or disconnect the wireless charging module and the charging circuit to or from each other; and
a microcontrol unit controlling the first and second switches and the DC/DC converter so as to supply the wireline and wireless powers to the main and auxiliary batteries or stop the supply of the wireline and wireless powers to the main and auxiliary batteries according to control signals for each charging mode.

3. The apparatus as set forth in claim 1, wherein the wireless charging module includes:
a wireless power receiver receiving the wireless power;
a rectifier rectifying the wireless power; and
a regulator stabilizing the rectified wireless power into a constant voltage.

4. The apparatus as set forth in claim 3, wherein the wireless charging module further includes a matcher matching an impedance between the wireless power receiver and the rectifier.

5. A method for charging wireline and wireless powers, the method comprising:
(A) simultaneously charging wireline and wireless powers in a main battery and an auxiliary battery when a first charging mode signal is input;
(B) determining whether a second charging mode signal is input and charging wireline power in the main battery and the auxiliary battery when the second charging mode signal is input; and
(C) determining whether a third charging mode signal is input and charging wireless power in the main battery and the auxiliary battery when the third charging mode signal is input.

6. The method as set forth in claim 5, wherein step (A) includes:
(A-1) simultaneously switching on a first switch installed between a wireline power receiver and a main battery and a second switch installed between a wireless charging module and a charging circuit when the first charging mode signal is input; and
(A-2) charging wireless power received from the wireless charging module in the charging circuit simultaneously with charging wireline power received from the wireline power receiver in the main battery to thereby charge the powers in the auxiliary battery connected to the charging circuit.

7. The method as set forth in claim 5, wherein step (B) includes:
(B-1) switching on a first switch installed between a wireline power receiver and the main battery when the second charging mode signal is input;
(B-2) charging wireline power received from the wireline power receiver in the main battery;
(B-3) determining whether the charging of the power in the main battery is completed;
(B-4) switching on a second switch installed between the wireline power receiver and a charging circuit when the charging of the power in the main battery is completed; and
(B-5) charging wireline power received from the wireline power receiver in the charging circuit to thereby charge the wireline power in the auxiliary battery connected to the charging circuit.

8. The method as set forth in claim 5, wherein step (C) includes:
(C-1) switching on a second switch installed between a wireless charging module and a charging circuit when the third charging mode signal is input;
(C-2) charging wireless power received from the wireless charging module in the charging circuit to thereby charge the wireless power in the auxiliary battery connected to the charging circuit;
(C-3) determining whether a charging amount of the wireless power charged in the auxiliary battery is a preset value or more;
(C-4) determining whether a main battery charging signal is input when the charging amount of the wireless power is the preset value or more; and
(C-5) converting the wireless power in the auxiliary battery to thereby charge the converted power in the main battery when the main battery charging signal is input.
